(19) United States
(12) Patent Application Publication
(10) Pub. No.: US 2022/0404476 A1
(43) Pub. Date: Dec. 22, 2022

(54) OPTOELECTRONIC SENSOR AND METHOD FOR DETECTING OBJECTS

(71) Applicant: Sick AG, Waldkirch (DE)

(72) Inventors: Roger BUSER, Waldkirch (DE); Tamara BRENDER, Waldkirch (DE); Jonathan PFEIL, Waldkirch (DE); Florian LEMKE, Waldkirch (DE)

(21) Appl. No.: 17/828,899

(22) Filed: May 31, 2022

(30) Foreign Application Priority Data
Jun. 18, 2021 (EP) 21180419.0

(51) Int. Cl. G01S 7/4865; G01S 17/10; G01S 7/481; G02B 5/08; G02B 5/10

(52) U.S. Cl. CPC G01S 7/4865; G01S 17/10; G01S 7/4817; G02B 5/085; G02B 5/10

(57) ABSTRACT

An optoelectronic sensor (10) is provided for the detection of objects in a monitored zone (20) that has a light transmitter (12) for transmitting transmitted light (16), a laser scanner (26) for generating a received signal from received light (22) from the monitored zone (20), a movable deflection unit (18) for the periodic deflection of the transmitted light (16) and of the received light (22), a control and evaluation unit (32) for the detection of information on objects in the monitored zone (20) using the received signal, and an optical deflection element (18, 40), in the optical path of the received light (22), In this respect, the deflection element (18, 40) has temperature dependent beam shaping properties.

The invention relates to an optoelectronic sensor, in particular to a laser scanner, and to a method for detecting objects in a monitored zone.

Optoelectronic systems and particularly laser scanners are suitable for detections and distance measurements that make a large horizontal angular range of the measurement system necessary. In a laser scanner, a light beam generated by a laser periodically sweeps over a monitored zone with the help of a deflection unit. The light is remitted at objects in the monitored zone and is evaluated in the laser scanner. A conclusion is drawn on the angular location of the object from the angular position of the deflection unit and additionally on the distance of the object from the laser scanner from the time of flight while using the speed of light in a phase method or pulse method. The location of an object in the monitored zone is detected in two-dimensional polar coordinates using the angular data and the distance data. The positions of objects can thus be determined or their contour can be determined.

In addition to such measurement applications, laser scanners are also used in safety technology for monitoring a hazard source, such as a hazardous machine. Such a safety laser scanner is known from DE 43 40 756 A1. In this process, a protected field is monitored which may not be entered by operators during the operation of the machine. If the laser scanner recognizes an unauthorized intrusion into the protected field, for instance a leg of an operator, it triggers an emergency stop of the machine. Sensors used in safety engineering have to work particularly reliably and must therefore satisfy high safety demands, for example the EN13849 standard for safety of machinery and the machinery standard EN61496 for electrosensitive protective equipment (ESPE).

The detection sensitivity of simple photodiodes is not sufficient in a number of application cases. In an avalanche photodiode (APD), the incident light triggers a controlled avalanche effect. The charge carriers generated by incident photons are thus multiplied and a photocurrent is produced that is proportional to the received light intensity, but that is in this respect substantially larger than with a simple PIN diode. In so-called Geiger mode, the avalanche photodiode is biased above the breakdown voltage such that a single charge carrier released by a single photon can already trigger an avalanche that then recruits all the available charger carriers due to the high field strength. The avalanche photodiode thus, like the eponymous Geiger counter, counts individual events. Avalanche photodiodes in Geiger mode are also called SPADs (single photon avalanche diodes) and corresponding light receivers are called multi-pixel photon counters (MPCCs) or silicon photomultipliers (SiPMs).

In APDs, the electronic system is more temperature dependent so that a tracking of the high voltage has to take place. There are more inherent noise sources'; they are limited in the relationship of area to bandwidth and are generally more expensive. All this speaks in favor of a light receiver based on SPADs or an SiPM. However, in single photon detection, not only a useful light photon, but also a weak interference event due to extraneous light, optical crosstalk, or dark noise triggers the avalanche effect. This interference event then contributes to the measured result with the same relatively strong signal as the received useful light and can also not be distinguished therefrom out of the signal. The avalanche photodiode operated in Geiger mode subsequently remains insensitive for a dead time of approximately 5 to 100 ns and is down for further measurements for this time. With APD or PIN diodes, in contrast, there is the possibility of electronically discharging transverse current caused by extraneous light.

For these reasons, a particularly effective suppression of extraneous light with respect to useful light is in particular to be aimed for, with these measures equally accruing to light receivers of a different technology. A strategy comprises not allowing extraneous light to penetrate to the light receiver at all. This is done by spectral separation by means of optical bandpasses, a reduction of unwanted scatter or reflection distances in the sensor, and a targeted reduction of the acceptance angle, preferably by means of a diaphragm before the light receiver.

The acceptance angle is proportional to the quotient of the field stop area and the focal length of a reception optics. The focal length in turn typically varies by several percentage points over the specified temperature range of the sensor. This variation is typically added to the tolerance chain and ultimately increases the field stop diameter and thus the acceptance angle of the system. However, it has to be accepted here that more extraneous light is detected.

DE 10 2009 055 988 B3 describes an apparatus for the optical scanning and measuring of an environment that uses a converging lens and a downstream multiple deflection to a light receiver. A color camera is arranged on the optical axis of the reception lens here that records color images of the environment of the laser scanner.

A lidar sensor in accordance with DE 10 2017 209 294 A1 having a multi-beam light source for transmitting light beams uses a directional filter, a converging primary mirror element and a scattering secondary mirror element in the optical reception path.

In a laser scanner in accordance with EP 3 246 729 B1, a converging mirror that combines the function of the reception optics and the beam folding in itself is used as the optics. Such a reception-side beam guidance is also proposed in an embodiment of U.S. Pat. No. 7,544,945 B2.

However, these documents do not pursue any approaches to compensate the temperature-induced focal length change of a reception optics. Only EP 3 246 729 B1 looks at this aspect at all and avoids a reception lens and with it its temperature effect. This is a possible procedure, but a reception lens is absolutely justified and advantageous so that its elimination does not address the actual problem.

EP 3 699 637 B1 deals with a laser scanner that compensates a refractive influence of a front screen on transmitted or received light that passes through, inter alia by a corresponding shape of the rotating mirror. The described effects of temperature changes are not thereby reduced.

EP 3 699 638 B1 describes a laser scanner having a co-rotating screening device for the transmitted light. The optical reception path is very conventionally guided over a flat rotating mirror and a reception lens without further deflections.

It is therefore the object of the invention to enable an improved measurement with a sensor of the category.

This object is satisfied by an optoelectronic sensor, in particular a laser scanner, and by a method for detecting objects in a monitored zone in accordance with the respective independent claim. A light transmitter generates transmitted light and transmits it into the monitored zone. The transmitted light is received again as remitted transmitted light after it has been at least partly reflected back from an object in the monitored zone. Received light is thus produced in which the remitted transmitted light is superposed with extraneous light. As long as no object is sensed, only extraneous light forms the received light. A scan movement, preferably a rotational movement, is produced with the aid of a moving deflection unit, by which scan movement the transmitted light and the received light are periodically transmitted at different deflection angles or are detected from different deflection angles.

The respective received signal is evaluated to acquire optically detectable information on the object such as a piece of binary presence information, a distance, a position, or also a color or a remission capability. The control and evaluation unit is preferably configured to determine a distance of the object from a time of flight between the transmission of the transmitted light and the reception of the received light. A distance measuring sensor is thus produced and the distance of the object is determined as the piece of measurement information on the object.

An optical deflection element, in particular a mirror element, by which the received light is deflected is arranged in the optical path of the received light. Depending on the embodiment, this deflection can be involved in the periodic deflection or can itself be the periodic deflection or it is an additional deflection that is not responsible for the periodic deflection and is preferably arranged downstream thereof.

The invention starts from the basic idea of carrying out a temperature compensation with the deflection element. The deflection element has a beam shaping that is temperature dependent for this purpose. The deflection element is in particular curved and a focal length can thus be associated with the deflection element. This curvature and thus the focal length changes by a targeted deformation over a known temperature range. The possible curvature states can include a flat, non-curved state for a specific temperature. In accordance with the invention, a targeted thermal adaptation is achieved that produces the desired temperature dependent changes of beam shaping properties. Not only unavoidable temperature effects to which all objects are subjected are meant by this. This would, for example, not allow a flat mirror to become a bundling or scattering mirror and the change would anyway be undefined; it would have a random effect and would therefore have an additional interference and non-compensating effect.

The invention has the advantage that the visible solid angle for a temperature range of, for example, 100° C. remains small. Thermal influences in the optical reception path are fully or partly reduced, for instance the inherent change of the focal length of the reception lens via he temperature, by preferably passive, alternatively also active compensation by means of the deflection element. A small light spot and thus high spatial resolution, and a small extraneous light introduction are thereby achieved. No enlarged acceptance solid angle has to be provided to compensate temperature tolerances. This improves the conditions for the use of highly sensitive avalanche photodiodes in Geiger mode (SPAD, single photo avalanche diode or SiPM, silicon photomultiplier) that are erroneously triggered by extraneous light and are then no longer available for useful light in a dead time. The robust extraneous light concept can be implemented inexpensively and can be retrofitted in existing systems.

The deflection element preferably has only a single mirror surface, with a plurality of separate mirror elements being alternatively conceivable in the same plane with a common effect of a mirror, in particular mirror elements disposed very close to one another. A further conceivable variant uses the front and rear sides of a mirror having a mutual spacing of 1-2 mm, for example.

The sensor preferably has a reception optics, in particular having at least one refractive element or a reception lens, for bundling the received light on the light receiver. The reception optics preferably guides the received light while bundling or focusing the received light on the light receiver. Only a single reception lens is particularly preferably used for reasons of a simple setup. The reception optics or reception lens is preferably produced from plastic. The enables an inexpensive manufacture and any desired shaping, including additional functions such as fixing connections and the like. An alternative glass lens has a more robust temperature range, but reduces the design freedom and the price is in particular considerably higher with large aspheric lenses.

The temperature-dependent beam shaping properties of the deflection element preferably counteract a temperature-dependent change of the beam shaping properties of the reception optics in a compensatory manner. The deflection element and the reception optics particularly preferably undergo a mutually opposite focal length change on a temperature change. The deflection element in other words has a temperature range inverse to the reception optics. It provides a change of the beam shaping properties, in particular of the focal length, in an opposite direction to that of the reception optics. This has the objective that the focal location at least substantially remains the same on temperature changes.

A diaphragm is preferably arranged in front of the light receiver, in particular at a distance corresponding to the focal length of the reception optics, i.e. the reception optics focuses the received light on the diaphragm aperture. The compensating temperature range of the deflection element provides that this focal location is maintained even though the focal length of the reception optics changes due to the temperature. The acceptance angle or the diaphragm aperture can thereby remain small without considering temperature changes or without a tolerance reserve therefor. As much extraneous light as possible is cut off at the outer cross-section of the received light without impairing the useful light.

The deflection element is preferably flat at a desired temperature, in particular at room temperature, and has a convex or concave curvature on a deviation from the desired temperature depending on the sign of the deviation. If the focal length of the reception optics accordingly varies with the temperature, this is compensated by a compensating change of the focal length of the deflection element. Depending on the direction in which compensation is to be made, the deflection element is given a converging effect and thus a positive focal length or a scattering effect and thus a negative focal length of suitable size. The resting state at the desired temperature is a flat deflection element that leaves the beam shaping properties of the reception optics optimized for this situation unchanged, in particular its focal length with a focal location at a diaphragm aperture in front of the light receiver. A flat deflection element, for example in the form of a planar glass mirror, can achieve a high quality optical design very inexpensively.

The deflection element preferably has only a convex curvature or only a concave curvature over a temperature range specified for the sensor, in particular including the boundary case of a flat deflection element at a margin of the temperature range. In this alternative, the deflection element now does not deform between convex and concave about a flat starting shape, but rather either remains always convex or always concave depending on the embodiment. As the temperature changes, the degree of convex or concave deformation varies; the deflection element adopts different radii of curvature. The boundary case of a flat deflection element at the lowest or highest specified temperature can still be included, i.e. the shape then varies between flat and convex or between flat and concave or vice versa.

The deflection element preferably has at least two materials having different temperature extents. There are particularly preferably exactly two materials. This makes possible a passive design of the deflection element that adapts to the temperature on its own. No control or circuit is required for this.

The deflection element preferably has at least two layers of the materials. The layer thicknesses and materials together with their thermal coefficient of expansion are free parameters of the implementation of the deflection element.

The sensitivity toward temperature changes can thus be set to achieve the desired compensating temperature dependent beam shaping properties of the deflection element. A third or a further material or a third and a further layer in particular relates to the case of an additional protective layer or a layer system on a carrier layer or a plurality of carrier layers.

The deflection element preferably has a core composed of the one material that is surrounded by the other material, in particular a metal core having surrounding plastic. The surrounding material has to give way to the core on temperature changes. The core preferably has a small thermal coefficient of expansion as in the case of metal and therefore responds correspondingly little to the temperature change. The basic shape thus remains specified by the core and the desired different curvature results from the surrounding material.

The core is preferably annular. The surrounding material that varies with the temperature then adopts a form symmetrical about the center axis on the expansion and compression. A curvature change results over the whole surface with a radial form comparable over the periphery. This actually corresponds to the desired focal length change.

An actuator element is preferably associated with the deflection element for its deformation and the actuator element is controlled to set temperature dependent beam shaping properties. This is an active embodiment, for example on the basis of a piezoceramic material. The deflection element is brought into the respective shape matching the temperature by the actuator element.

The sensor preferably has a temperature sensor and/or a light sensitive measurement element for determining a beam cross-section of the received light. With knowledge of the reception path of the sensor, the changes of the optical reception path can be predicted from the measured temperature using a theoretical model; said changes can be practically checked by the light sensitive measurement element. It can be used for diagnostic purposes. In interplay with an actuator element, a temperature regulation can thus be built up for the resulting beam shaping of the reception optics and the deflection element. The light sensitive measurement element can, for example, be placed in an annular manner around a diaphragm aperture.

The movable deflection unit is preferably configured as a rotating mirror having a mirror surface. The rotating mirror is typically at an angle of 45° so that transmitted light is generated along the axis or rotation or received light is received along the axis of rotation and a plane perpendicular to the axis of rotation is scanned by the 90° deflection by the rotating mirror. The mirror surface is preferably the only mirror surface of the rotating mirror. It is then therefore not a polygonal mirror wheel. Laser scanners are alternatively known in which the total measuring head with the light transmitter and the light receiver rotates.

The deflection element is preferably arranged to move with the deflection unit. In the case of a deflection unit configured as a rotating mirror, the deflection element preferably simultaneously forms the mirror surface of the rotating mirror in a dual function. The temperature compensation is consequently achieved by a special design of the rotating mirror.

The deflection element is preferably configured as a folding mirror arranged downstream of the reception optics in the optical reception path of the received light. In this embodiment function, the deflection element is not part of the deflection unit and is in particular a separate component from a rotating mirror and is arranged after it. The optical reception path is folded by the folding mirror, it is given a new direction, and the optical reception path is in particular partially led back into itself. Longer light distances can thereby be accommodated in a smaller space. The folding mirror is particularly preferably arranged downstream of the reception optics. Received light that is beam shaped or focused by the reception optics and that is then deflected to the light receiver by the folding mirror is thus incident on the folding mirror. A temperature compensation of the beam shaping is superposed on the folding by the dual function of the folding mirror as the deflection element in accordance with the invention.

A reflective surface of the folding mirror is preferably adapted to the optical reception path, in particular in annular form with a non-reflective center and a ring segment corresponding to a cast shadow in the optical reception path. This reduces the input of extraneous light and thus improves the signal-to-noise ratio. Due to the adaptation, the folding mirror does not reflect any additional extraneous light from regions in the light receiver in which no useful light is incident. An annular shape is suitable when the light receiver is seated at a center of the optical reception path. Incident received light is then shadowed there so that centrally reflected light can only be extraneous light. A corresponding cast shadow can be produced by the light transmitter and a carrier element for the light receiver and/or light receivers and can be considered in the shaping of the reflective surfaces.

The folding mirror is preferably configured and arranged such that the received light is directed directly in the direction of the light receiver. This means that there is only one single folding mirror and not a plurality of folding mirrors and thus deflections after one another are not required before the received light is conducted to the light receiver in the new direction. The received light from the monitored zone is thus first guided by the deflection unit through the reception optics to the folding mirror and then from the folding mirror to the light receiver; further changes of direction of the optical reception path are not provided. Optical elements such as filters or diaphragms are still possible between the folding mirror and the light receiver, but not new deflection elements or mirrors.

The folding mirror is preferably oriented perpendicular to the optical path of the received light incident thereon. In this respect, a lens plane of a reception optics configured as a reception lens and the folding mirror are preferably in parallel with one another, even more preferably also the receiver plane of the light receiver. The received light incident on the folding mirror is thus reflected back or, apart from tolerances and the like, is deflected by 180°. Due to a bundling effect of the reception optics, the reflection angle of the individual beams of the received light is not 180°; however a common direction of the total bundle of rays of the received light can be specified to which that applies; for example, a central reflection angle, or it is again alternatively preferably defined via the reception optics whose optical axis is perpendicular to the folding mirror. The light receiver is preferably arranged between the deflection unit and the folding mirror. Neither the deflection of the folding mirror nor of further deflection elements then guide the received light for the light receiver into a plane on the other side of the folding mirror.

The sensor preferably has a transmission tube, that is moved at least partially with the deflection unit, to screen the transmitted light. The transmission tube so-to-say surrounds the optical transmission path and prevent scattered light from the transmitted light being produced within the sensor before exiting into the monitored zone. A transmission optics of the light transmitter is preferably arranged in the transmission tube for beam shaping, in particular for collimating the transmitted light.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

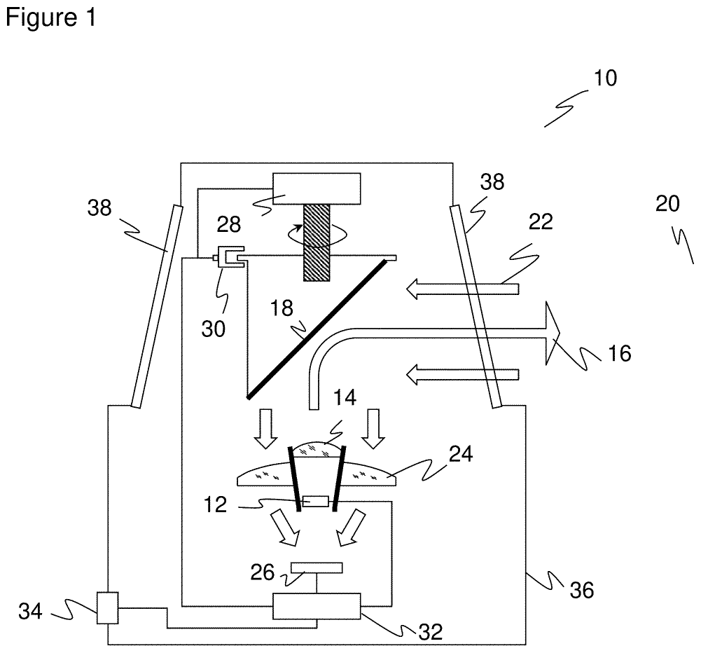

FIG. 1 a schematic representation of a laser scanner;

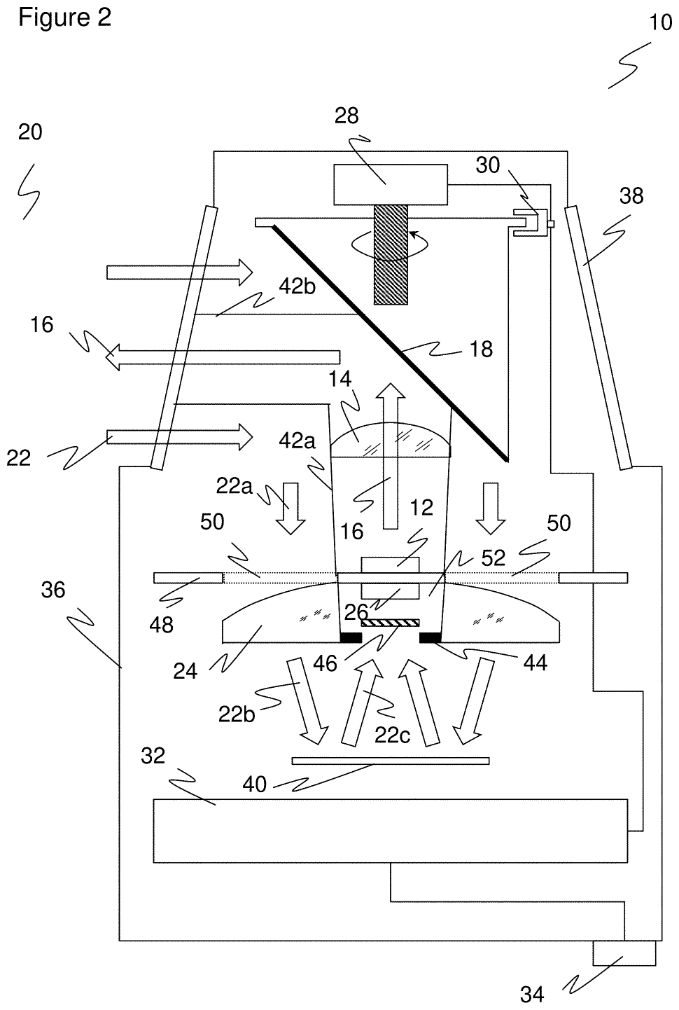

FIG. 2 a schematic representation of a laser scanner with a folding mirror;

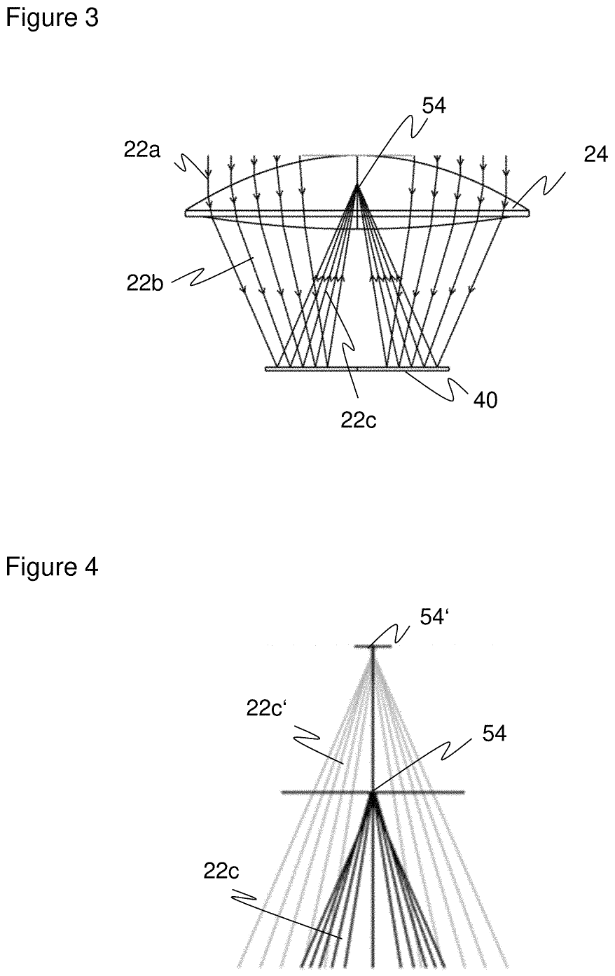

FIG. 3 a representation of the optical reception path in the laser scanner in accordance with FIG. 2 after a reception optics;

FIG. 4 a sectional representation of the optical reception path in accordance with FIG. 3 on a focal length change of the reception optics due to different temperatures;

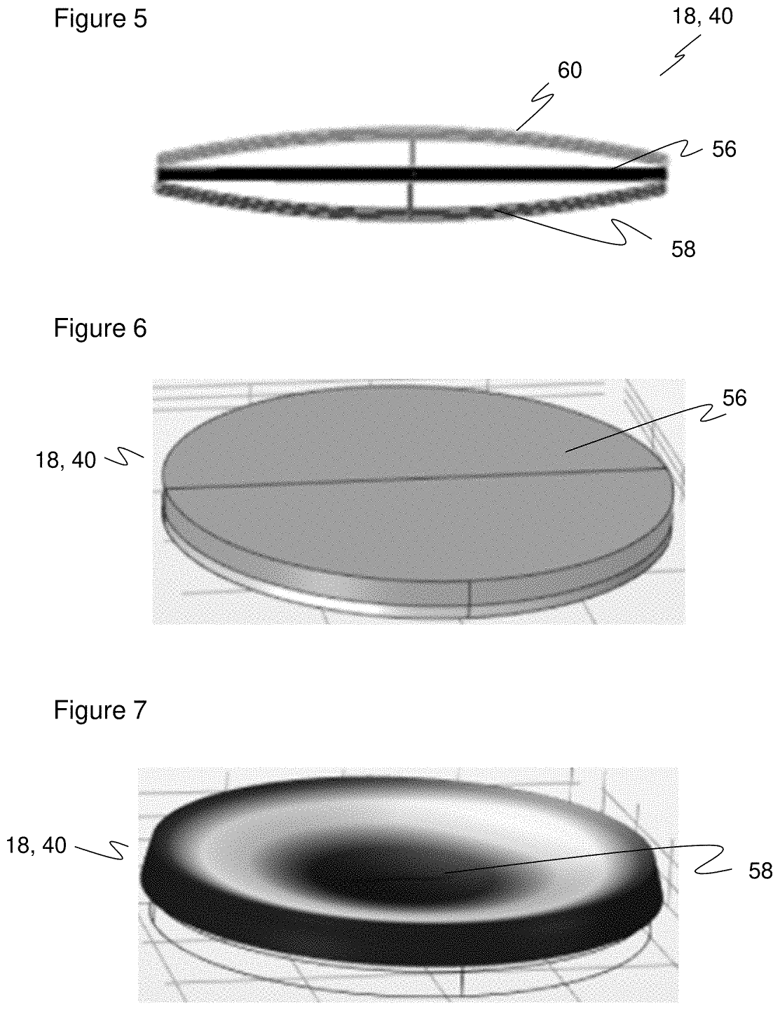

FIG. 5 a schematic representation of different shapes of a deflection element at different temperatures;

FIG. 6 a three-dimensional representation of a deflection element in a flat state,

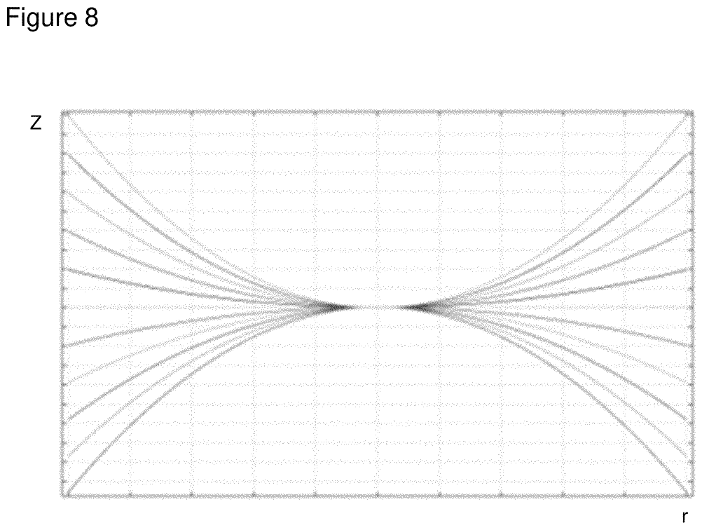

FIG. 7 a three-dimensional representation of a deflection element in a concavely curved state; and

FIG. 8 a representation of different curvatures of a deflection element at different temperatures.

FIG. 1 shows a schematic sectional representation through an optoelectronic sensor in an embodiment as a laser scanner 10. A light transmitter 12, for example having a laser light source, generates a transmitted light beam 16 with the aid of a transmission optics 14. The transmitted light beam 16 is transmitted into a monitored zone 20 by means of a deflection unit 18. To avoid optical cross-talk, the transmitted light beam 16 can be at least partly surrounded by a transmission tube, not shown.

The transmitted light beam 16 is remitted by an object that may be present in the monitored zone 20. The corresponding received light 22 again arrives back at the laser scanner 10 and is detected by a light receiver 26 via the deflection unit 18 by means of an optical reception optics 24. The reception optics 24 is preferably a single converging lens, but further lenses and other optical elements can be added. The light receiver 26, for example, has at least one photodiode or, for higher sensitivity, an avalanche photodiode (APD) or an arrangement having at least one single photon avalanche diode (SPAD, SiPM).

The deflection unit 18 is set into a continuous rotational movement having a scan frequency by a motor 28. The transmitted light beam 16 thereby scans one plane during each scan period, that is on a complete revolution at the scanning frequency. An angle measurement unit 30 is arranged at the outer periphery of the detection unit 18 to detect the respective angular position of the detection unit 18. The angle measurement unit 30 is here formed by way of example by an encoder wheel as an angular standard and a forked light barrier as a scanning device.

A control and evaluation unit 32 is connected to the light transmitter 12, to the light receiver 26, to the motor 28, and to the angle measurement unit 30. A conclusion is drawn on the distance of a scanned object from the laser scanner 10 using the speed of light by determining the time of flight between the transmission of the transmitted light beam 16 and the reception of remitted received light 22. The respective angular position at which the transmitted light beam 16 was transmitted is known to the evaluation unit from the angular measurement unit 30.

Two-dimensional polar coordinates of the object points in the monitored zone 20 are thus available via the angle and the distance after every scan period and corresponding measured data can be transmitted via an interface 34. The interface 34 can conversely be used for a parameterization or other data exchange between the laser scanner 10 and the outside world. The interface 34 can be designed for communication in one or more conventional protocols such as IO link, Ethernet, Profibus, USB3, Bluetooth, wireless LAN, LTE, 5G and many others. In applications in safety engineering, the interface 34 can be configured as safe and can in particular be a safe output (OSSD, output signal switching device) for a safety-relevant shut-down signal on recognition of a protective field infringement. The laser scanner 10 is accommodated in a housing 36 that has a peripheral front screen 38.

In the laser scanner 10 shown, the light transmitter 12 and its transmission optics 14 are located in a central opening of the reception optics 24. This is only an exemplary possibility of the arrangement. The invention additionally comprises alternative coaxial solutions, for instance having their own mirror region for the transmitted light beam 16 or having beam splitters, and also biaxial arrangements.

The deflection unit 18 appears as a flat rotating mirror in FIG. 1. In accordance with the invention, however, the rotating mirror is curved differently in dependence on the temperature, with, in dependence on the embodiment, one curvature being present for all temperatures or with the flat form being adopted at a specific temperature. The reason for the temperature dependent deformation, for the design of the deformation, and for possible measures to achieve them will be explained below with reference to FIGS. 3 to 8.

FIG. 2 shows a further embodiment of a laser scanner 10 in which, instead of the rotating mirror of the deflection unit 18, an additional folding mirror 40 is curved differently in dependence on the temperature. Here the same features are provided with the same reference numerals and will not be explained again. The optical transmission path is screened in FIG. 2 by an optional one-part or two-part transmission tube 42a-b already addressed in FIG. 1. At least the second part 42b of the transmission tube is moved along with the deflection unit 18 into the monitored zone 20 by the deflection unit 18.

Unlike the laser scanner 10 in accordance with FIG. 1, the received light 22 is additionally defected in the laser scanner 10 shown in FIG. 2 and is respectively given a different reference numeral for better distinguishability in the sequential parts of the reception light path. The received light 22a deflected by the deflection unit 18 is incident on the reception optics 24. The received light 22b beam shaped or bundled there is incident on the folding mirror 40. The received light 22c reflected back by the folding mirror 40 is then incident on the light receiver 26 through a diaphragm 44 and after passing through an optical filter 46 that is coordinated to the wavelength of the light transmitter 12. The order of the diaphragm 44 and the optical filter 46 can be reversed.

The light transmitter 12 and the light receiver 26 are arranged on a common circuit board 48, that has a cutout 50 for the passage of the received light 22a, in the embodiment shown in FIG. 2. Alternatively, respective separate circuit boards are conceivable. The reception optics 24 has a central opening 52 in which the diaphragm 44, the optical filter 46, and the light receiver 26 are accommodated. In alternative embodiments, the light receiver 26 can be arranged beneath the reception optics 24 that then does not necessarily still have a central opening 52. Instead of the central opening 52, the reception optics 24 can have a further beam shaping element at its center. The reception optics 24 then in particular forms an outer zone for the received light 22a on the forward run and the further beam shaping element forms an inner zone for the received light 22c on the return path after reflection at the folding mirror 40.

The folding mirror 40 can be equipped with spectrally filtering properties in an adaptation to a wavelength of the light transmitter 12, either by coatings, structures, or a filter element, and replaces or complements the optical filter 46 in this manner. The optical filter 46 has the advantage that the cross-section of the received light 22c and the angular range of the beams incident there are is tightly bounded there. A small optical filter 46 having a narrow bandwidth is therefore possible by which extraneous light outside the wavelength of the transmitted or useful light is particularly inexpensively and effectively filtered.

Just as in FIG. 1, the rotating mirror of the deflection unit 18 is shown as flat in simplified form; FIG. 2 shows a flat folding mirror 40 in simplified form. In the following, a temperature dependent deformation of the rotating mirror or folding mirror in accordance with the invention is presented by which a temperature range in the optical reception path is compensated, in particular the reception optics 24. Depending on the temperature and on the embodiment, the rotating mirror and/or folding mirror 40 adopt different shapes or curvatures here, with again, in dependence on the embodiment, a flat state being conceivable at a specific temperature or one curvature remaining present over all temperatures. Furthermore, complementary to the embodiments in accordance with FIG. 1 or FIG. 2, it is conceivable that there are further deflection elements that can each contribute to the compensation, or not, by temperature dependent deformation. Instead of a laser scanner 10 having a deflection unit 18 designed as a rotating mirror, a laser scanner is conceivable having a rotating measuring head in which the light transmitter and/or light receiver and at least one deflection element that deforms in dependence on the temperature are moved along in the optical reception path.

FIG. 3 again shows the folded optical reception path 22a-c in the laser scanner 10 in accordance with FIG. 2 in enlarged form and in more detail. Thanks to the folding mirror 40, the construction space between the reception optics 24 and the folding mirror 40 is used twice so that the optical reception path is also accommodated with a longer focal length of the reception optics 24. The folded received light 22c has a smaller angle fan that permits the design of an optical filter 46 having small dimensions and a narrow bandpass. The diaphragm 44 can be arranged in a focal location 54 and can thus effectively suppress extraneous light that is incident at a shallower angle.

FIG. 4 illustrates in a sectional enlargement of the optical reception path a temperature effect of the beam shaping or focusing. The favorable situation of FIG. 3 is only achieved at a specific temperature, for example room temperature of 20° C. At a changed temperature, for example a higher temperature of 70° C., the focal length of the reception optics 24 adjusts itself. A displaced focal location 54′ and thus an enlarged cross-section of the received light 22c′ in the diaphragm plane results for the received light 22c′ at the changed temperature. A diaphragm 44 arranged at the original focal location 54 then, depending on the design of the diaphragm aperture that allows tolerances or not, either blocks useful light or allows additional extraneous light to pass through. This temperature effect is particularly pronounced with a reception optics 24 of plastic, in particular a plastic lens. Plastic, however, has advantages in manufacture, design, and price with respect to the less temperature sensitive glass.

FIG. 5 illustrates a compensating temperature dependent deformation of the folding mirror 40 or analogously the rotating mirror of the deflection unit 18 in an embodiment of a laser scanner 10 in accordance with FIG. 1. The folding mirror or rotating mirror now called a deflection element in an overarching manner adopts a flat shape 56 as a nominal mirror at a desired temperature, for example room temperature. An elevated temperature effects an increasingly concavely curved shape 58; accordingly a reduced temperature effects an increasingly convexly curved shape 60. A temperature dependent focal length extent of the deflection element thus result that is opposite to that of the reception optics 24, and indeed, where possible, also quantitatively to the same degree. The resulting focal length in the optical reception path is thereby constant in the ideal case and in any case fluctuates considerably less due to the compensating deformation of the deflection element.

A deformation or change of the radius of curvature of the deflection element over temperature can be achieved by a skillful pairing of different materials. A layer structure of at least two materials is preferably selected. The basic idea is similar to a bimetallic strip, but with a considerably more precise deformation being achieved, and preferably not only metals, but, for example, the combination of a metal and a plastic or another material combination of plastics and/or metals, being used. The layers are configured in their thicknesses and materials with a respective thermal coefficient of expansion just so that a deformation of the deflection element acting opposite to the temperature behavior of the reception optics 24 is achieved in a very targeted manner. In this respect, a specified temperature range around the room temperature of 20° is considered, for example over a temperature interval of a total of 100° C. that corresponds to a permitted working environment of the laser scanner 10.

FIGS. 6 and 7 show, complementary to the schematic representation of FIG. 5, an embodiment of the deflection element having a mirror coated topmost layer in a three-dimensional representation. FIG. 6 here shows the flat shape 56, i.e. a non-deformed mirror surface at environmental temperature; and FIG. 7 shows an exemplary deformation to a concavely curved form 58 at 50° C. excess temperature.

FIG. 8 shows an exemplary temperature range of the deflection element. The effective thickness or extent in the Z direction is applied perpendicular to the mirror surface against the radius r of the deflection element. A circular shape of the deflection element is here only assumed in a simplifying manner; in practice, the deflection element can also have a different geometry. Each curve stands for the curvature at a specific temperature; from top to bottom at a maximum temperature having the largest concave curvature over less pronounced concave curvature to a flat shape at room temperature as the convex curvature increases up to a maximum convex curvature at minimal temperatures. Changes in the radius of curvature up to +/−1 mm can be achieved for an exemplary pairing of Corning glass 9740 having a thickness of 1 mm and aluminum having a thickness of 0.5 mm.

In the embodiments shown, the deflection element adopts a flat shape at room temperature and the temperature range having a convex and concave deformation is so-to-day centered around it. In other embodiments, the flat shape is adopted at a higher or lower temperature up to the marginal case of a flat shape at a maximum temperature or minimum temperature. The shape then varies between slightly convex and highly convex or slightly concave and highly convex or between flat and convex or flat and concave. In again different embodiments, the deflection element is anyway no longer flat at all in the specified temperature range, i.e. the temperature range varies from slightly convex to highly convex or slightly concave to highly concave. The direction of the curvature change in dependence on the temperature is predefined by the desired compensating effect opposite to the focal length change of the reception optics 24.

Alternatively to a deflection element of two layers, it is conceivable to surround a core of at least one material with at least one further material. An example for this is a ring of metal that is surrounded by plastic. With a larger coefficient of expansion of the plastic with respect to the metal, the plastic body escapes laterally as the temperature increases. The deflection element is dimensioned for low temperatures such that the desired opposite curvature is produced in that, for example a predefined curvature is applied to the non-effective side of the mirror.

An again alternative embodiment uses an actuator system; it, for example, replaces the passive non-reflective layer of the deflection element with an actively controllable piezoceramic material. The radius of curvature of the laminar structure can be controlled by it The shape of the deflection element is, for example, controlled or regulated using a temperature determined by a temperature sensor. It is furthermore conceivable to measure the beam cross-section of the received light 22c, for instance using a photodiode at the margin of the diaphragm aperture, to determine the matching control.

1. An optoelectronic sensor for the detection of objects in a monitored zone, the optoelectronic sensor comprising:
a light transmitter for transmitting transmitted light,
a laser scanner for generating a received signal from received light from the monitored zone,
a movable deflection unit for the periodic deflection of the transmitted light and of the received light,
a control and evaluation unit for the detection of information on objects in the monitored zone using the received signal and
an optical deflection element in the optical path of the received light, wherein the deflection element has temperature dependent beam shaping properties.

2. The sensor in accordance with claim 1,
wherein the control and evaluation unit is configured for a distance measurement using a time of flight measurement.

3. The sensor in accordance with claim 1,
wherein the optical deflection element is a mirror element.

4. The sensor in accordance with claim 1,
wherein the deflection element has a temperature dependent curvature.

5. The sensor in accordance with claim 1,
that has a reception optics for bundling the received light on the light receiver.

6. The sensor in accordance with claim 5,
wherein the reception optics comprises a reception lens for bundling the received light on the light receiver.

7. The sensor in accordance with claim 1,
wherein the temperature dependent beam shaping properties of the deflection element counteract a temperature dependent change of the beam shaping properties of the reception optics in a compensatory manner.

8. The sensor in accordance with claim 7,
wherein the deflection element and the reception optics undergo a mutually opposite focal length change on a temperature change.

9. The sensor in accordance with claim 1,
wherein a diaphragm is arranged upstream of the light receiver.

10. The sensor in accordance with claim 9,
wherein the diaphragm is arranged upstream of the light receiver at a distance corresponding to the focal length of the reception optics.

11. The sensor in accordance with claim 1,
wherein the deflection element is flat at a desired temperature and has a convex or concave curvature on a deviation from the desired temperature depending on the sign of the deviation.

12. The sensor in accordance with claim 1,
wherein the desired temperature is room temperature.

13. The sensor in accordance with claim 1,
wherein the deflection element has only a convex curvature or only a concave curvature over a temperature range specified for the sensor.

14. The sensor in accordance with claim 13,
wherein the temperature range specified for the sensor includes the boundary case of a flat deflection element at a margin of the temperature range.

15. The sensor in accordance with claim 1,
wherein the deflection element has at least two materials having different temperature extents.

16. The sensor in accordance with claim 15,
wherein the deflection element has at least two layers of the materials.

17. The sensor in accordance with claim 15,
wherein the deflection element has a core composed of the one material that is surrounded by the other material.

18. The sensor in accordance with claim 17,
wherein the core is a metal core having surrounding plastic.

19. The sensor in accordance with claim 17,
wherein the core is annular.

20. The sensor in accordance with claim 1,
wherein an actuator element is associated with the deflection element for its deformation and the actuator element is controlled to set temperature dependent beam shaping properties.

21. The sensor in accordance with claim 1,
that has a temperature sensor and/or a light sensitive measurement element for determining a beam cross-section of the received light.

22. The sensor in accordance with claim 1,
wherein the deflection element is arranged co-moving with the deflection unit.

23. The sensor in accordance with claim 1,
wherein the deflection element is arranged co-moving with the deflection unit and forms the deflection unit as a rotating mirror.

24. The sensor in accordance with claim 1,
wherein the deflection element is configured as a folding mirror arranged downstream of the reception optics in the optical reception path of the received light.

25. A method of detecting objects in a monitored zone in which transmitted light is transmitted, is received again as received light after remission at the object, and is converted into a received signal by a light receiver to generate a piece of object information from the received signal, wherein transmitted light and received light are periodically deflected with the aid of a movable deflection unit and the received light is deflected by a deflection element, wherein beam shaping properties of the deflection element change with the temperature.
